(19) United States
(12) Patent Application Publication
(10) Pub. No.: US 2017/0213042 A1
(43) Pub. Date: Jul. 27, 2017

(54) DATA ENCRYPTION METHOD AND ENCRYPTION APPARATUS

(71) Applicant: Huawei Device Co., Ltd., Shenzhen (CN)

(72) Inventor: Dong ZHANG, Wuhan (CN)

(21) Appl. No.: 15/330,816

(22) PCT Filed: May 7, 2014
(86) PCT No.: PCT/CN2014/076928

§ 371 Date: Nov. 7, 2016

(51) Int. Cl. G06F 21/60; G06F 17/30; G06F 3/06

(52) U.S. Cl. CPC G06F 21/602; G06F 3/0623; G06F 3/0659; G06F 3/067; G06F 17/30233; G06F 17/3012; G06F 2212/402

(57) ABSTRACT

The present invention provides a data encryption method, and the method includes: writing collected data into a memory; encrypting the collected data in the memory; and writing the encrypted data into an external storage. The present invention further provides a corresponding encryption apparatus. By using the encryption method and the encryption apparatus that are provided in the present invention, in a process of writing data into a file, the written data may be encrypted, and when the file is stored to an external storage, encryption of the file is implemented, thereby effectively ensuring timeliness of data encryption.

### CROSS-REFERENCE TO RELATED APPLICATIONS

This application is a national stage of International Application No. PCT/CN2014/076928, filed on May 7, 2014, which is hereby incorporated by reference in its entirety.

### TECHNICAL FIELD

The present invention relates to the field of information technologies, and in particular, to a data encryption method and an encryption apparatus.

### BACKGROUND

With continuous development of mobile communications technologies, functions of a mobile terminal are no longer limited to making calls and sending SMS messages. The mobile terminal is capable of supporting file information processing, for example, document storing and reading, email sending, receiving, and saving, video shooting, and picture editing. However, an increase in files that are processed on the mobile terminal imposes an information security problem of the mobile terminal.

To resolve the information security problem of the mobile terminal, currently, encryption processing is performed on a file in an external storage on the terminal mainly by using an encryption application program. For example, encryption processing is performed on user privacy information such as a video, an audio, a picture, or a document. In such a data encryption method, an existing file is encrypted generally by changing a type of the file to an unidentifiable file type or by hiding the original file at a disk address that a user cannot access. However, this method applies to encryption of a file that has been stored in the external storage. After the file is stored in the external storage and before the file is encrypted, the file is in an unencrypted state, and incurs a leakage risk. Therefore, the existing data encryption method has a problem that encryption is not in time.

### SUMMARY

Embodiments of the present invention provide an encryption method and an encryption apparatus, so as to overcome a problem in the prior art that data encryption is not in time.

A first aspect of the embodiments of the present invention provides a data encryption method, including:

writing collected data into a memory;

encrypting the collected data in the memory; and

writing the encrypted data into an external storage.

With reference to the first aspect of the embodiments of the present invention, in a first possible implementation manner of the first aspect, after the writing collected data into a memory, the method further includes:

creating a new file on the external storage; and

the writing the encrypted data into an external storage includes:

writing the encrypted data into the new file.

With reference to the first possible implementation manner of the first aspect of the embodiments of the present invention, in a second possible implementation manner of the first aspect, after the writing collected data into a memory, the method further includes:

generating a file name corresponding to the collected data and a storage path of the collected data, where the storage path points to the external storage; and

determining, according to the file name and the storage path, whether a file whose name is the same as the file name exists in the storage path; and

the creating a new file on the external storage includes:

if it is determined that no file whose name is the same as the file name exists in the storage path, creating a new file on the external storage.

With reference to the second possible implementation manner of the first aspect of the embodiments of the present invention, in a third possible implementation manner of the first aspect, after the writing collected data into a memory, the method further includes:

invoking an open function; and

after the open function is invoked, routing an open operation instruction from a server of a virtual file system to a client that is of the virtual file system and corresponds to a file system type supported by the external storage;

the determining, according to the file name and the storage path, whether a file whose name is the same as the file name exists in the storage path includes:

determining, by using the client of the virtual file system, whether a file whose name is the same as the file name exists in the storage path; and

the creating a new file on the external storage includes: creating a new file on the external storage by using the client of the virtual file system.

With reference to the third possible implementation manner of the first aspect of the embodiments of the present invention, in a fourth possible implementation manner of the first aspect, the method further includes:

after the new file is created on the external storage, invoking a write function; and

after the write function is invoked, routing a write operation instruction from the server of the virtual file system to the client of the virtual file system; and

the encrypting the collected data in the memory includes:

encrypting the collected data by using the client of the virtual file system.

With reference to the first aspect or the first to the fourth possible implementation manners of the first aspect of the embodiments of the present invention, in a fifth possible implementation manner of the first aspect, the encrypting the collected data in the memory includes: adding encryption information to the collected data; and

the writing the encrypted into an external storage includes:

writing, into the external storage, the data to which the encryption information is added.

With reference to the fifth possible implementation manner of the first aspect of the embodiments of the present invention, in a sixth possible implementation manner of the first aspect, the adding encryption information to the collected data includes:

attaching the encryption information to data of a predetermined length in the collected data.

A second aspect of the embodiments of the present invention provides an encryption apparatus, and the encryption apparatus includes:

a write unit, configured to write collected data into a memory;

an encryption unit, configured to encrypt the collected data in the memory; and

a storage unit, configured to write data obtained by the encryption unit by means of encryption processing into an external storage.

With reference to the second aspect of the embodiments of the present invention, in a first possible implementation manner of the second aspect, the apparatus further includes a creation unit, where the creation unit is configured to create a new file on the external storage after the write unit writes the collected data into the memory, where

the storage unit is configured to write the encrypted data into the new file.

With reference to the first possible implementation manner of the second aspect of the embodiments of the present invention, in a second possible implementation manner of the second aspect, the apparatus further includes a generation unit and a determining unit, where

the generation unit is configured to: after the write unit writes the collected data into the memory, generate a file name corresponding to the collected data and a storage path of the collected data, where the storage path points to the external storage; and

the determining unit is configured to determine, according to the file name and the storage path that are generated by the generation unit, whether a file whose name is the same as the file name exists in the storage path, where

the creation unit is specifically configured to: if the determining unit determines that no file whose name is the same as the file name exists in the storage path, create a new file on the external storage.

With reference to the second possible implementation manner of the second aspect of the embodiments of the present invention, in a third possible implementation manner of the second aspect, the apparatus further includes an invoking unit and a routing unit, where

the invoking unit is configured to: after the write unit writes the collected data into the memory, invoke an open function; and

the routing unit is configured to: after the invoking unit invokes the open function, route an open operation instruction from a server of a virtual file system to a client that is of the virtual file system and corresponds to a file system type supported by the external storage, where

the determining unit is specifically configured to determine, by using the client of the virtual file system, whether a file whose name is the same as the file name exists in the storage path; and

the creation unit is specifically configured to create a new file on the external storage by using the client of the virtual file system.

With reference to the third possible implementation manner of the second aspect of the embodiments of the present invention, in a fourth possible implementation manner of the second aspect, the invoking unit is further configured to: after the creation unit creates the new file on the external storage, invoke a write function;

the routing unit is further configured to: after the invoking unit invokes the write function, route a write operation instruction from the server of the virtual file system to the client of the virtual file system; and

the encryption unit is specifically configured to encrypt the collected data by using the client of the virtual file system.

With reference to the second aspect or the first to the fourth possible implementation manners of the second aspect of the embodiments of the present invention, in a fifth possible implementation manner of the second aspect, that the encryption unit is configured to encrypt the collected data in the memory includes: adding encryption information to the collected data; and

the storage unit is specifically configured to write, to the external storage, the data to which the encryption information is added.

With reference to the fifth possible implementation manner of the second aspect of the embodiments of the present invention, in a sixth possible implementation manner of the second aspect, the encryption unit is specifically configured to attach the encryption information to data of a predetermined length in the collected data.

In the embodiments of the present invention, first, encryption processing is performed on collected data that is written into a memory; and then, the encrypted data is written into an external storage, so that encryption is completed at the same time when the collected data is written into the external storage. Therefore, in the embodiments of the present invention, collected data can be encrypted in time, steps are simple, and efficiency of encrypting the collected data is high.

### BRIEF DESCRIPTION OF DRAWINGS

To describe the technical solutions in the embodiments of the present invention or in the prior art more clearly, the following briefly introduces the accompanying drawings required for describing the embodiments or the prior art. Apparently, the accompanying drawings in the following description show merely some embodiments of the present invention, and a person of ordinary skill in the art may still derive other drawings from these accompanying drawings without creative efforts.

FIG. 1 is a schematic flowchart of an existing encryption method;

FIG. 2 is a schematic flowchart of an encryption method according to an embodiment of the present invention;

FIG. 3 is a schematic flowchart of another encryption method according to an embodiment of the present invention;

FIG. 4 is a schematic structural diagram of a hierarchy of a system according to an embodiment of the present invention;

FIG. 5 is a schematic structural diagram of an encryption apparatus according to an embodiment of the present invention;

FIG. 6 is a schematic structural diagram of another encryption apparatus according to an embodiment of the present invention; and

FIG. 7 is a schematic structural diagram of still another encryption apparatus according to an embodiment of the present invention.

### DESCRIPTION OF EMBODIMENTS

The following clearly and completely describes the technical solutions in the embodiments of the present invention with reference to the accompanying drawings in the embodiments of the present invention. Apparently, the described embodiments are merely some but not all of the embodiments of the present invention. All other embodiments obtained by a person of ordinary skill in the art based on the embodiments of the present invention without creative efforts shall fall within the protection scope of the present invention.

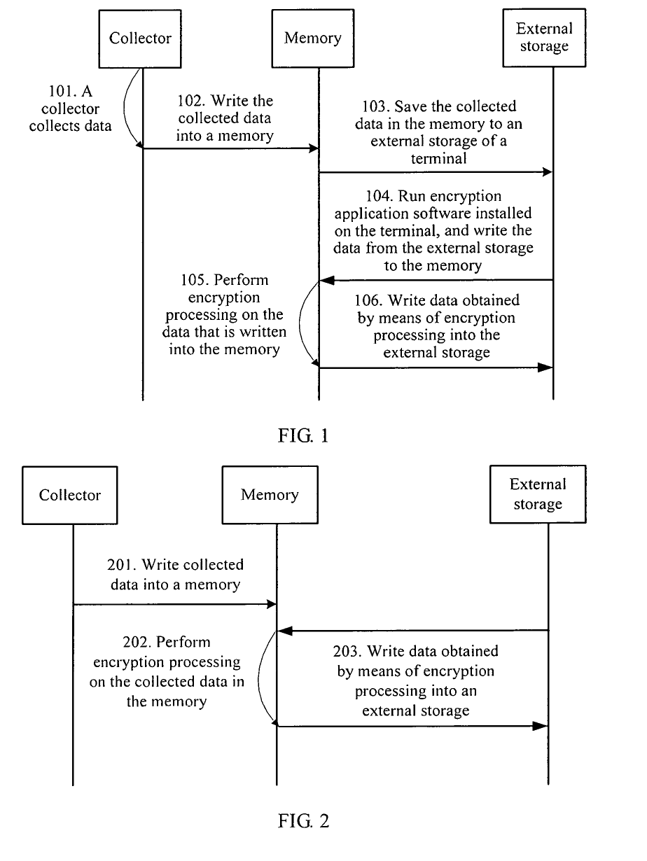

Before the embodiments of the present invention are described, an existing process of encrypting collected data by a terminal is described first, where the terminal may be a smartphone, a tablet computer, or the like. As shown in FIG. 1, this encryption process is as follows: 101. The terminal collects data by using a collector on the terminal. For example, a mobile phone uses a camera of the mobile phone for shooting, so as to obtain photo data. 102. Write the collected data into a memory. 103. Save the collected data in the memory to an external storage of the terminal. 104. Run encryption application software installed on the terminal, and write the data from the external storage to the memory. 105. Encrypt the data that is written into the memory. 106. Write the encrypted data into the external storage. It can be learned from the foregoing steps that, by running the encryption application software on the terminal, encryption processing can be performed only on the data that is written from the external storage into the memory, and encryption processing cannot be directly performed on data that is collected by the collector and is not stored to the external storage. Therefore, according to an existing encryption method, encryption cannot be performed in time. In addition, before encryption is completed, the data in the external storage is easily leaked out, and there is security vulnerability.

After the prior art is learned, the following describes the present invention in detail by illustrating the embodiments of the present invention.

As shown in FIG. 2, an embodiment of the present invention provides a data encryption method. The method may be applied to a terminal such as a mobile phone and a tablet computer, and the method includes:

201. Write collected data into a memory.

Before step 201, a collector on the terminal can be used to collect data. For example, a camera of the terminal is used to collect image data, and a recorder of the terminal is used to collect sound data. The data collected by the collector is written into the memory.

In this embodiment of the present invention, the collector may also be referred to as a collection module, and a form of the collection module is not limited, which may be a hardware form, or may be a software form, provided that data can be collected.

202. Encrypt the collected data in the memory.

For example, encryption information is added to the collected data, which may specifically include: attaching the encryption information to data of a predetermined length in the collected data.

In this embodiment of the present invention, an encryption manner is not limited, and an existing algorithm may be used.

203. Write the encrypted data into an external storage.

In this embodiment of the present invention, first, encryption processing is performed on collected data that is written into a memory; and then, the encrypted data is written into an external storage, so that encryption is completed at the same time when the collected data is written into the external storage. Therefore, in the present invention, collected data can be encrypted in time, steps are simple, and efficiency of encrypting the collected data is high.

It is easily understood that, for the “encryption is completed at the same time”, encryption is not fully synchronously completed in a strict sense. A proper time required for the encryption itself and a proper time required for running other software and hardware need to be appropriately considered. The “at the same time” is described relative to an existing encryption manner.

To better understand the embodiments of the present invention, the following describes in detail the embodiments of the present invention with reference to a procedure for processing data by a file system of a terminal.

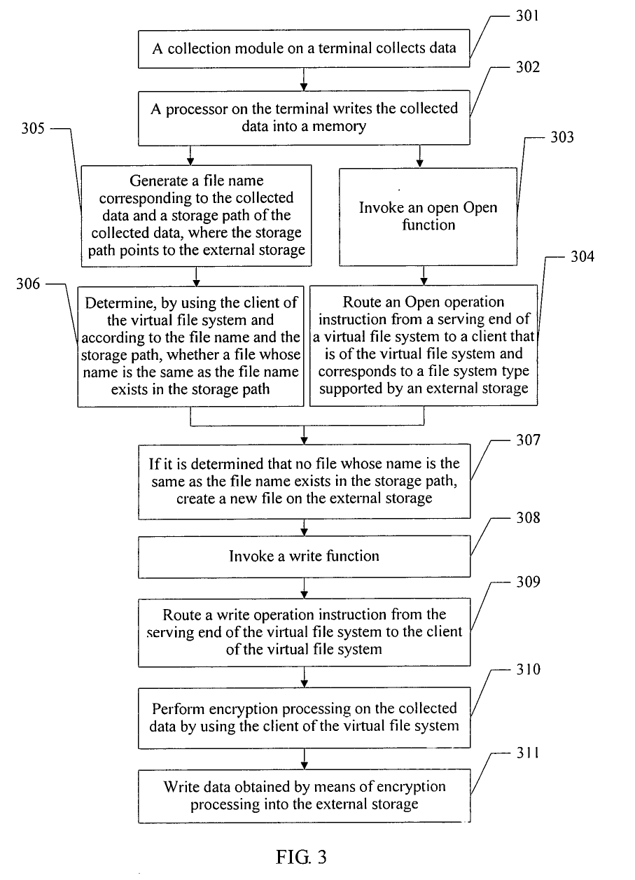

As shown in FIG. 3, an embodiment of the present invention further provides a data encryption method, and the method includes:

301. A collection module on a terminal collects data.

The collection module may include a shooting module, a recording module, and the like. For example, a user runs shooting software on the terminal and starts the shooting module for shooting a picture. The shooting module collects image data.

302. A processor on the terminal writes the collected data into a memory.

After the collected data is written into the memory, an operation is performed on the collected data by using a virtual file system of the terminal.

After step 302 is performed, step 303 and step 305 are separately performed, which does not mean that step 303 and step 305 need to be simultaneously performed after step 302 is performed.

303. Invoke an open function.

A purpose of invoking the open function is to create a file.

304. Route an open operation instruction from a server of a virtual file system to a client that is of the virtual file system and corresponds to a file system type supported by an external storage.

305. Generate a file name corresponding to the collected data and a storage path of the collected data, where the storage path points to the external storage.

306. Determine, by using the client of the virtual file system and according to the file name and the storage path, whether a file whose name is the same as the file name exists in the storage path.

307. If it is determined that no file whose name is the same as the file name exists in the storage path, create a new file on the external storage.

After the new file is created, step 308 is performed.

308. Invoke a write function.

309. Route a write operation instruction from the server of the virtual tile system to the client of the virtual file system.

310. Encrypt the collected data by using the client of the virtual file system.

Step 310 may include: attaching encryption information to data of a predetermined length in the collected data, where the encryption information may be attached to the end of the data of the predetermined length. For example, when the data is written into the new file, the encryption information is attached to the data of the predetermined length, so that an encrypted file is formed after the writing into the new file is completed. The encryption information may be obtained by means of calculation by using a hash (hash) algorithm and according to a public key or a private key.

311. Write the encrypted data into the external storage.

The external storage may include a storage medium that connects to the terminal, such as a removable storage, a hard disk, or an optical disc.

According to the encryption method provided in this embodiment of the present invention, in a process of writing data into a file, the written data is automatically encrypted by using a file system, which effectively ensures encryption timeliness. In addition, a user does not need to encrypt the data by manually running encryption application software, which brings convenience for the user.

The following better describes the embodiments of the present invention with reference to a specific application.

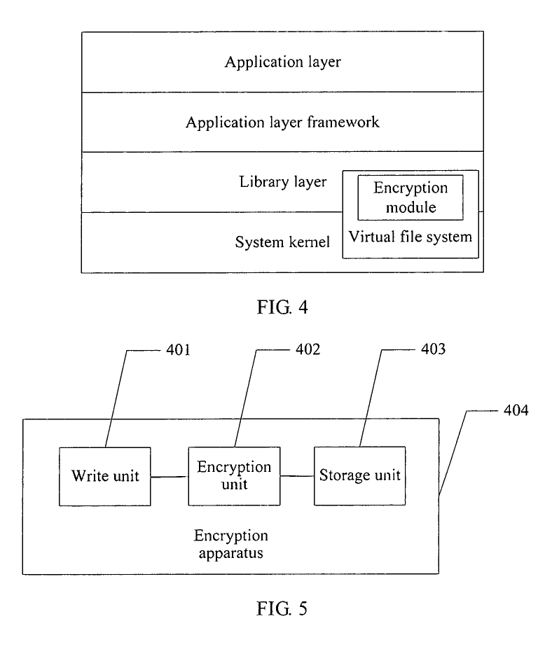

As shown in FIG. 4, a system architecture used by a mobile terminal contains from top to bottom: an application layer, an application layer framework, a library layer (LIBRARIES, lib for short), a system kernel, and the system architecture further contains a virtual file system, where the virtual file system is implemented in user space and kernel space. The user space includes the application layer, the application layer framework, and the library layer, and the kernel space includes the system kernel. A server of the virtual file system is implemented in the kernel space, a client of the virtual file system is implemented in the user space, and an encryption module may be integrated on the client of the virtual file system. When a user mode process is started, and the file system is invoked, an operation instruction is routed from the server of the virtual file system to the client of the virtual file system. The user mode process may include any one of application program processes such as video shooting, photo taking, recording, and a gallery. When data is written into a file, the client of the virtual file system adds, based on an encryption algorithm, encryption information to the data that is written into the file, so as to implement data encryption. Afterwards, the client of the virtual file system invokes a physical file system at a bottom layer, and stores the encrypted data to disk space on an external storage. Therefore, in the embodiments of the present invention, file encryption is implemented by using the file system, and file encryption is implemented at the bottom layer, which does not affect running of an upper-layer application program and has features such as a low cost, high portability, and maintainability.

In the embodiments of the present invention, a particular encryption public key can be set based on a group. A special group user uses a public key by default; in this way, an encrypted media tile generated by any user on a mobile terminal of the user can be shared with a member in the group, and other members obtain a decrypted file by means of decryption by using the public key. Alternatively, an encryption private key may be set. In this way, an encrypted file can be identified by only a current mobile terminal, and cannot be identified by other mobile terminals.

As shown in FIG. 5, an embodiment of the present invention provides an encryption apparatus 404, and the encryption apparatus includes:

a write unit 401, configured to write collected data into a memory;

an encryption unit 402, configured to encrypt the collected data in the memory; and

a storage unit 403, configured to write data obtained by the encryption unit 402 by means of encryption processing into an external storage.

According to the encryption apparatus 404 provided in this embodiment of the present invention, first, encryption processing is performed on collected data that is written into a memory; and then, the encrypted data is written into an external storage, so that encryption is completed at the same time when the collected data is written into the external storage. Therefore, in the present invention, collected data can be encrypted in time, steps are simple, and efficiency of encrypting the collected data is high.

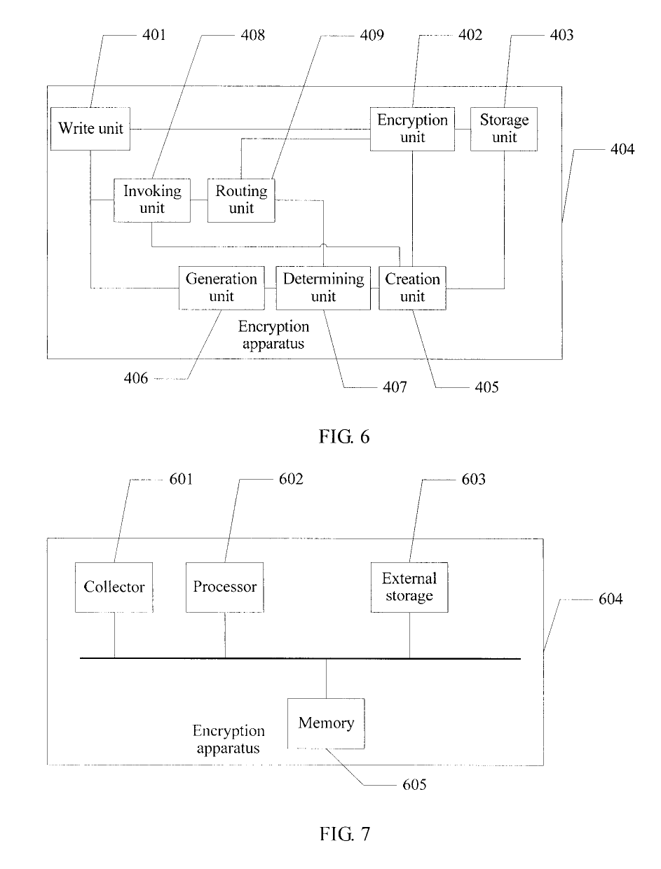

As shown in FIG. 6, the encryption apparatus 404 further includes a creation unit 405, where the creation unit 405 is configured to create a new file on the external storage after the write unit 401 writes the collected data into the memory, where

the storage unit 403 is configured to write the encrypted data into the new file.

Optionally, the encryption apparatus 404 further includes a generation unit 406 arid a determining unit 407, where

the generation unit 406 is configured to: after the write unit 401 writes the collected data into the memory, generate a file name corresponding to the collected data and a storage path of the collected data, where the storage path points to the external storage; and

the determining unit 407 is configured to determine, according to the file name and the storage path that are generated by the generation unit 406, whether a file whose name is the same as the file name exists in the storage path, where

the creation unit 405 is specifically configured to: if the determining unit 407 determines that no file whose name is the same as the file name exists in the storage path, create a new file on the external storage.

Optionally, the encryption apparatus 404 further includes an invoking unit 408 and a routing unit 409, where

the invoking unit 408 is configured to: after the write unit 401 writes the collected data into the memory, invoke an open function; and

the routing unit 409 is configured to: after the invoking unit 408 invokes the open function, route an open operation instruction from a server of a virtual file system to a client that is of the virtual file system and corresponds to a file system type supported by the external storage, where

the determining unit 407 is specifically configured to determine, by using the client of the virtual file system, whether a file whose name is the same as the file name exists in the storage path; and

the creation unit 405 is specifically configured to create a new file on the external storage by using the client of the virtual file system.

Optionally, the invoking unit 408 is further configured to: after the creation unit 405 creates the new file on the external storage, invoke a write function;

the routing unit 409 is further configured to: after the invoking unit 408 invokes the write function, route a write operation instruction from the server of the virtual file system to the client of the virtual file system; and

the encryption unit 402 is specifically configured to encrypt the collected data by using the client of the virtual file system.

Optionally, the encryption unit 402 is specifically configured to add encryption information to the collected data; and

the storage unit 403 is configured to write, to the external storage, the data to which the encryption information is added.

Optionally, the encryption unit 402 is configured to attach the encryption information to data of a predetermined length in the collected data.

As shown in FIG. 7, an embodiment of the present invention provides a terminal 604, and the terminal includes a collector 601, a processor 602, a memory 605, and an external storage 603, where the processor 602 is separately connected to the collector 601, the memory 605, and the external storage 603. The collector 601 includes a camera, a recorder, and the like.

The collector 601 is configured to collect data. For example, the camera is configured to collect image data, and the recorder is configured to collect sound data.

The processor 602 is configured to write the data collected by the collector 601 into the memory 605, encrypt the collected data in the memory 605, and write the encrypted data into the external storage 603.

Optionally, the processor 602 is configured to create a new file on the external storage after writing the data collected by the collector 601 into the memory; and

the processor 602 is configured to write the encrypted data into the new file.

Optionally, the processor 602 is configured to: after writing the data collected by the collector 601 into the memory 605, generate a file name corresponding to the collected data and a storage path of the collected data, where the storage path points to the external storage 603; and determine, according to the file name and the storage path, whether a file whose name is the same as the file name exists in the storage path; and

the processor 602 is configured to: if determining that no file whose name is the same as the file name exits in the storage path, create a new file on the external storage 603.

Optionally, the processor 602 is configured to: after writing the data collected by the collector 601 into the memory 605, invoke an open function; and after invoking the open function, route an open operation instruction from a server of a virtual file system to a client that is of the virtual file system and corresponds to a file system type supported by the external storage 603;

the processor 602 is specifically configured to determine, by using the client of the virtual file system, whether a file whose name is the same as the file name exists in the storage path; and

the processor 602 is configured to create a new file on the external storage 603 by using the client of the virtual file system.

Optionally, the processor 602 is configured to: after creating the new file on the external storage 603, invoke a write function; and after invoking the write function, route a write operation instruction from the server of the virtual file system to the client of the virtual file system.

The processor 602 is specifically configured to encrypt the collected data by using the client of the virtual file system.

Optionally, the processor 602 is specifically configured to add encryption information to the collected data; and

the processor 602 is configured to write, to the external storage 603, the data to which the encryption information is added.

Optionally, the processor 602 is configured to attach the encryption information to data of a predetermined length in the collected data.

A person of ordinary skill in the art may understand that all or some of the processes of the methods in the embodiments may be implemented by a computer program instructing relevant hardware. The program may be stored in a computer-readable storage medium. When the program runs, the processes of the methods in the embodiments are performed. The foregoing storage medium may include: a magnetic disk, an optical disc, a read-only memory (Read-Only Memory, ROM), or a random access memory (Random Access Memory, RAM).

The foregoing describes in detail a data encryption method and an encryption apparatus that are provided in the embodiments of the present invention. In this specification, specific examples are used to describe the principle and implementation manners of the present invention, and the description of the embodiments is only intended to help understand the method and core idea of the present invention. Meanwhile, a person of ordinary skill in the art may, based on the idea of the present invention, make modifications with respect to the specific implementation manners and the application scope. Therefore, the content of this specification shall not be construed as a limitation to the present invention.

1. A data encryption method, implemented by a terminal, comprising:
collecting data;
writing the collected data into a memory of the terminal;
encrypting the collected data in the memory;
creating a new file on a storage of the terminal;
writing the encrypted data into the file of the storage.

2. (canceled)

3. The method according to claim 1, wherein after the writing collected data into the memory, the method further comprises:
generating a file name corresponding to the collected data and a storage path of the collected data, wherein the storage path points to the storage; and
determining, according to the file name and the storage path, whether a file whose name is the same as the file name exists in the storage path; and
the creating a new file on the storage of the terminal, comprises:
creating a new file on the storage when it is determined that no file whose name is the same as the file name exists in the storage path.

4. The method according to claim 3, wherein after the writing collected data into a memory, the method further comprises:
invoking an open function; and
after the open function is invoked, routing an open operation instruction from a server of a virtual file system to a client that is of the virtual file system and corresponds to a file system type supported by the storage;
the determining, according to the file name and the storage path, whether a file whose name is the same as the file name exists in the storage path comprises:
determining, by using the client of the virtual file system, whether a file whose name is the same as the file name exists in the storage path; and
correspondingly, the creating a new file on the storage comprises: creating a new file on the storage by using the client of the virtual file system.

5. The method according to claim 4, wherein the method further comprises:
after the new file is created on the storage, invoking a write function; and
after the write function is invoked, routing a write operation instruction from the server of the virtual file system to the client of the virtual file system; and
the encrypting the collected data in the memory comprises:
encrypting the collected data by using the client of the virtual file system.

6. The method according to claim 5, wherein the encrypting the collected data in the memory comprises:
adding encryption information to the collected data; and
the writing the encrypted data into the storage comprises:
writing, into the storage, the data to which the encryption information is added.

7. The method according to claim 6, wherein the adding encryption information to the collected data comprises:
attaching the encryption information to data of a predetermined length in the collected data.

8-14. (canceled)

15. A terminal, comprising:
a memory storing instructions; and
a processor coupled to the memory to execute the instructions to:
collect data;
write the collected data into the memory;
encrypt the collected data in the memory;
create a new file on a storage of the terminal;
write the encrypted data into the file of the storage;
generate a file name corresponding to the collected data and a storage path of the collected data, wherein the storage path points to the storage;
determine whether a file whose name is the same as the file name exists in the storage path according to the file name and the storage path; and
the creating a new file on the storage comprises:
creating a new file on the storage when it is determined that no file whose name is the same as the file name exists in the storage path.

16. The terminal according to claim 15, wherein the processor to further execute the instructions to:
invoke an open function after the writing collected data into the memory;
after the open function is invoked, route an open operation instruction from a server of a virtual file system to a client that is of the virtual file system and corresponds to a file system type supported by the storage;
the determine according to the file name and the storage path, whether a file whose name is the same as the file name exists in the storage path comprises:
determine whether a file whose name is the same as the file name exists in the storage path by using the client of the virtual file system; and
correspondingly, the creating a new file on the storage comprises: creating a new file on the storage by using the client of the virtual file system.

17. The terminal according to claim 16, wherein the processor to further execute the instructions to:
invoke a write function after the new file is created on the storage; and
route a write operation instruction from the server of the virtual file system to the client of the virtual file system after the write function is invoked; and
the encrypting the collected data in the memory comprises:
encrypting the collected data by using the client of the virtual file system.

18. The terminal according to claim 17, wherein the encrypting the collected data in the memory comprises:
adding encryption information to the collected data; and
the writing the encrypted data into an storage comprises:
writing, into the storage, the data to which the encryption information is added.
wherein the adding encryption information to the collected data comprises:
attaching the encryption information to data of a predetermined length in the collected data.
